(19) United States
(12) Patent Application Publication
(10) Pub. No.: US 2026/0277522 A1
(43) Pub. Date: Sep. 17, 2026

(54) RENDERING MULTI-LEVEL IMAGE QUALITY IN MULTI-USER SPLIT XR SYSTEMS

(71) Applicant: QUALCOMM Incorporated, San Diego, CA (US)

(72) Inventors: Kapil AHUJA, Bengaluru (IN); Pawan Kumar BAHETI, San Diego, CA (US); Wesley James HOLLAND, Encinitas, CA (US); Manmohan MANOHARAN, Bengaluru (IN); Simon Peter William BOOTH, San Diego, CA (US); Animesh BEHERA, Bengaluru (IN)

(21) Appl. No.: 19/168,725

(22) PCT Filed: Apr. 5, 2024
(86) PCT No.: PCT/US2024/023435

§ 371 Date: Sep. 24, 2025

(30) Foreign Application Priority Data
May 17, 2023 (IN) 202341034548

(51) Int. Cl. G06F 3/14; G06F 3/01; G06T 3/40; G06T 11/00; H04N 19/31; H04N 19/33

(52) U.S. Cl. CPC G06F 3/1431; G06F 3/012; G06T 3/40; G06T 11/00; H04N 19/31; H04N 19/33

(57) ABSTRACT

This disclosure provides systems, devices, apparatus, and methods, including computer programs encoded on storage media, for rendering multi-level image quality in multi-user split XR systems. A processor may obtain first capability information for a first wearable display device and second capability information for a second wearable display device. The processor may render, based on the first capability information, a first frame for the first wearable display device. The processor may render, based on the second capability information, a second frame for the second wearable display device. The processor may transmit the rendered first frame for the first wearable display device and the rendered second frame for the second wearable display device.

### CROSS REFERENCE TO RELATED APPLICATION(S)

This application claims the benefit of Indian Provisional Application No. 202341034548, entitled “RENDERING MULTI-LEVEL IMAGE QUALITY IN MULTI-USER SPLIT XR SYSTEMS” and filed on May 17, 2023, which is expressly incorporated by reference herein in its entirety.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for multiple user (multi-user) split extended reality (XR) rendering may not address different capabilities of different wearable display devices (WDDs). There is a need for improved techniques pertaining to multi-user split XR rendering.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: obtain first capability information for a first wearable display device and second capability information for a second wearable display device; render, based on the first capability information, a first frame for the first wearable display device; render, based on the second capability information, a second frame for the second wearable display device; and transmit the rendered first frame for the first wearable display device and the rendered second frame for the second wearable display device.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example multiple user split extended reality (XR) system in accordance with one or more techniques of this disclosure.

FIG. 5 is a diagram illustrating an example multiple user split XR system in accordance with one or more techniques of this disclosure.

FIG. 6 is a call flow diagram illustrating example communications between a companion device, and a first wearable display device (WDD), and a second WDD in accordance with one or more techniques of this disclosure.

FIG. 7 is a flowchart of an example method of graphics processing in accordance with one or more techniques of this disclosure.

FIG. 8 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, “mipmapping” may refer to a technique where a high-resolution texture is downscaled and filtered so that each subsequent multum in parvo (mip) (i.e., much in little) level is a quarter of the area of the previous level. A “vote” may refer to an indication of a choice or selection for a course of action. For instance, a vote may indicate that one action is more suitable or desirable compared to another action. Spatial scalable video encoding may refer to encoding performed using multiple spatial resolutions. Additionally, capability information may be any type of information that is associated with a capability of a device (e.g., a WDD). For example, the capability information may be associated with a number of different capabilities of the device (e.g., a resolution of the device, a frame rate of the device, a refresh rate of the device, a display size of the device, etc.).

An extended reality (XR) system (e.g., an augmented reality (AR) system, a virtual reality (VR) system, a mixed reality (MR) system) may include a companion device (e.g., a phone, a tablet, a desktop computing device, a laptop computing device, a server, etc.) and a wearable display device (WDD) (e.g., a head device, a head mounted display (HMD), glasses, etc.) that communicate over a wired or wireless connection, where the WDD may be worn on/over/around eye(s) of a user. Such an XR system may be referred to as a split XR system. The WDD may have less battery life and less computational power in comparison to battery life and computational power of the companion device. As such, rendering and other workloads may be offloaded to the companion device. For instance, the companion device may receive pose information (e.g., a six degree-of-freedom (6DOF) pose including position (xyz) and orientation (roll, pitch, yaw)) of the WDD and the companion device may render a frame of XR content (e.g., AR content, MR content, VR content, etc.) based on the pose information and transmit the frame to the WDD.

Some XR systems may include a companion device and multiple WDDs (e.g., a first WDD worn by a first user and a second WDD worn by a second user). Such XR systems may be referred to as multiple user split XR systems. In an example, the first WDD and the second WDD may be located relatively near one another (e.g., within the same room) and/or the first WDD and the second WDD may be oriented towards the same or a similar direction (e.g., the first user and the second user may be looking at the same point (or nearby points) in the room while wearing the first WDD and the second WDD, respectively). In an example, the first WDD may have first capabilities (e.g., a first supported resolution) and the second WDD may have second capabilities (e.g., a second supported resolution), where the first capabilities may be greater than the second capabilities. The companion device may render a frame and transmit the frame to the first WDD and the second WDD. The first WDD and the second WDD may each receive the frame, process the frame (e.g., perform a late stage reprojection (LSR) using latest available pose information), and display the processed frame. However, the first WDD and the second WDD may have different capabilities (e.g., different resolutions, different frame rates, etc.). The companion device may render the frame according to a lowest capability that is supported by both the first WDD and the second WDD so as to make the frame compatible with both the first WDD and the second WDD; however, this may not take full advantage of the first capabilities of the first WDD, which may lead to a diminished user experience at the first WDD.

Various technologies pertaining to rendering multiple level (multi-level) image quality in multi-user split XR systems are described herein. In an example, a companion device obtains first capability information for a first wearable display device and second capability information for a second wearable display device. The companion device renders, based on the first capability information, a first frame for the first wearable display device. The companion device renders, based on the second capability information, a second frame for the second wearable display device. The companion device transmits the rendered first frame for the first wearable display device and the rendered second frame for the second wearable display device. Vis-à-vis rendering the first frame according to the first frame based on the first capability information and the second frame based on the second capability information, the companion device may render frames tailored for each of the first wearable display device and the second wearable display device, which may improve user experience. Furthermore, as the rendered frames are tailored for each of the first wearable display device and the second wearable display device, the rendered frames may result in a more efficient use of computational resources of the companion device, as the companion device may avoid rendering frames with qualities that may not be utilized by a wearable display device. For example, if the first wearable display device is capable of 4K resolution and the second wearable display device is capable of 1080p resolution, the companion device may render a 4K frame and a 1080p frame (as opposed to two 1080p frames).

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

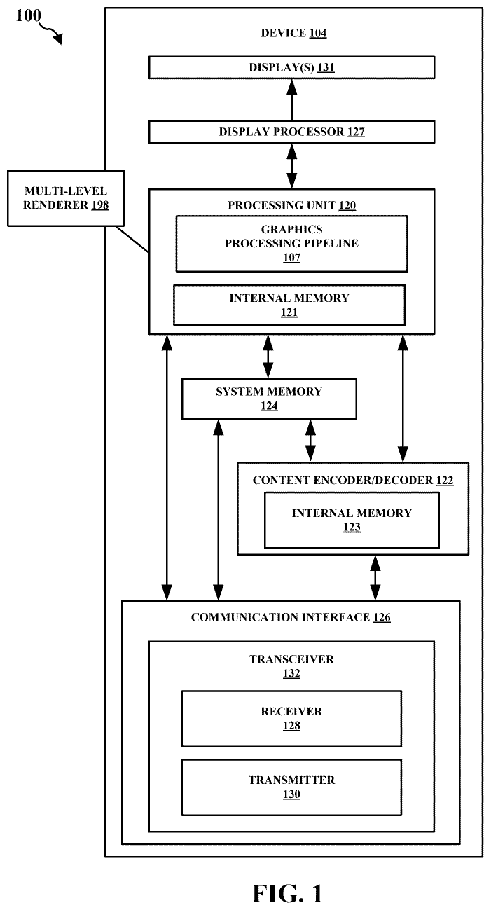

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a multi-level renderer 198 configured to obtain first capability information for a first wearable display device and second capability information for a second wearable display device; render, based on the first capability information, a first frame for the first wearable display device; render, based on the second capability information, a second frame for the second wearable display device; and transmit the rendered first frame for the first wearable display device and the rendered second frame for the second wearable display device. Although the following description may be focused on graphics processing, the concepts described herein may be applicable to other similar processing techniques. Furthermore, although the following description may be focused on wearable XR display devices, the concepts herein may also be applicable to non-wearable XR display devices.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

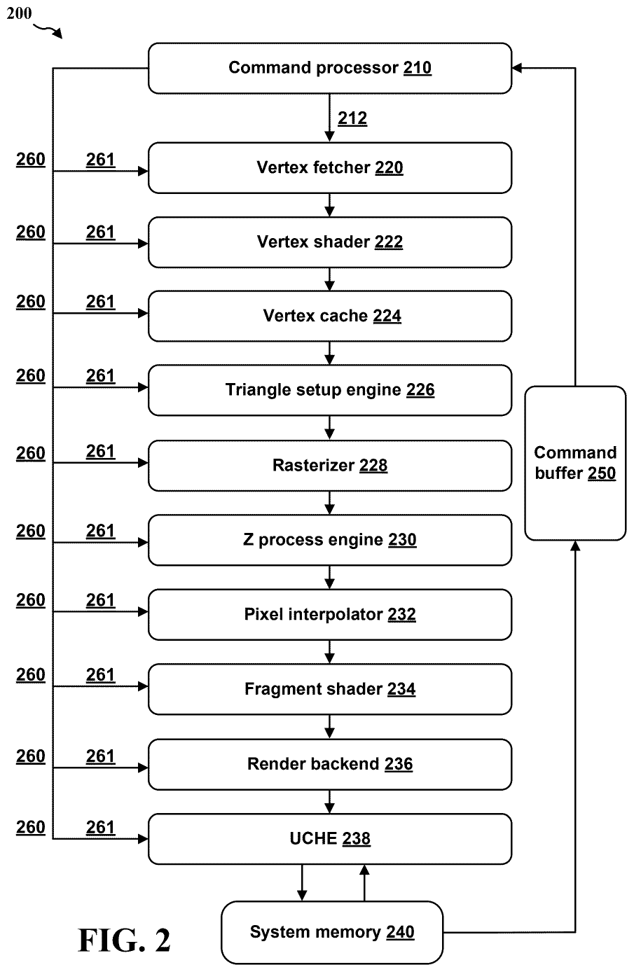

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

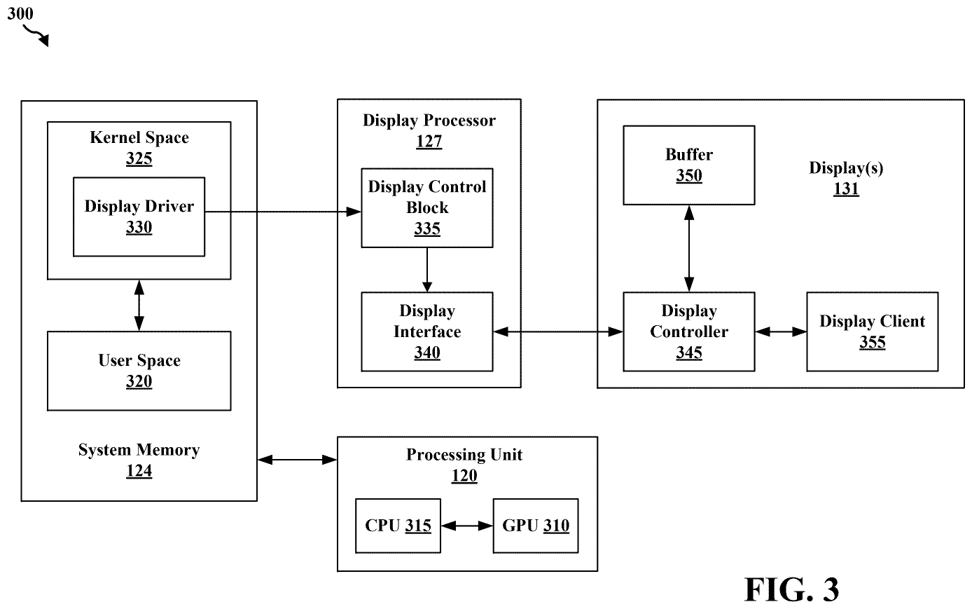

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. In some aspects, the HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

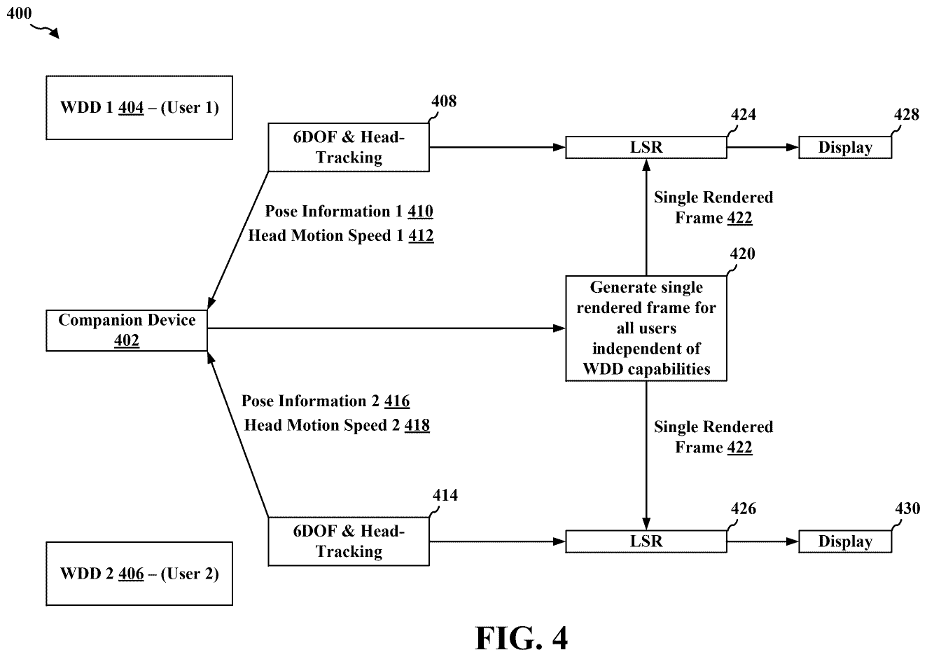

FIG. 4 is a diagram 400 illustrating an example multiple user split extended reality (XR) system in accordance with one or more techniques of this disclosure. The multiple user split XR system may include a companion device 402, a first WDD 404 worn by a first user, and a second WDD 406 worn by a second user. The first WDD 404 and the second WDD 406 may have first capabilities and second capabilities, respectively. For example, the first capabilities may include a first resolution of the first WDD 404, a first refresh rate of the first WDD 404, a first frame rate of the first WDD 404, and/or a first display size of a display of the first WDD 404 and the second capabilities may include a second resolution of the second WDD 406, a second refresh rate of the second WDD 406, a second frame rate of the second WDD 406, and/or a second display size of a display of the second WDD 406. The first capabilities and the second capabilities may be different. For instance, the first refresh rate of the first WDD 404 may be 120 Hz and the second refresh rate of the second WDD 406 may be 90 Hz.

The companion device 402 may be or include phone(s), such as smartphone(s), tablet(s), desktop computing device(s), laptop computing device(s), server(s), such as cloud servers, and/or gaming console(s). The companion device 402 may alternatively be referred to as a remote device, a companion, or a host. In an example, the first WDD 404 may be a first HMD or first XR glasses and the second WDD 406 may be a second HMD or second XR glasses. The first WDD 404 and the second WDD 406 may also be referred to as headsets. The companion device may be connected to the first WDD 404 and the second WDD 406 by wired connection(s) (e.g., universal serial bus (USB)) or wireless connection(s) (e.g., wireless local area network, 5G New Radio (NR), another cellular technology, etc.). In an example, the companion device 402 may be the device 104. In another example, the first WDD 404 may be the device 104. In yet another example, the second WDD 406 may be the device 104. Although the following description below focuses on two WDDs, the concepts presented below may be applicable to any number of WDDs (e.g., N wearable display devices, where N is a positive integer).

In general, the companion device 402 may be configured to render XR content and transmit the rendered XR content to the first WDD 404 and the second WDD 406. In general, the first WDD 404 and the second WDD 406 may be configured to receive the rendered XR content, process the rendered XR content (explained in greater detail below), and present the processed rendered XR content on display(s). In one aspect, a WDD (e.g., the first WDD 404, the second WDD 406, etc.) may include a first display and a second display. When the WDD is worn by a user, the first display and the second display may be located within several centimeters of a first eye of the user and a second eye of the user, respectively. The WDD may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user.

At 408, the first WDD 404 may determine first pose information 410 and a first head motion speed 412 of the first WDD 404 (and hence the first user). As used herein, pose information may refer to a current location (e.g., an xyz coordinate) and an orientation (e.g., a roll, a pitch, and a yaw) of a WDD (and hence, a head of a user of the WDD). Pose information may be alternatively referred to as a 6 degree-of-freedom pose (6DOF). As used herein, head motion speed may refer to a speed of a head of a user while the user wears a WDD. Determining a head motion speed may also be referred to as head-tracking. In an example, the first WDD 404 may determine the first pose information 410 and the first head motion speed 412 by way of an inertial measurement unit (IMU) and/or a camera of the first WDD 404. The first WDD 404 may transmit the first pose information 410 and/or an indication of the first head motion speed 412 to the companion device 402. The first WDD 404 may also transmit additional information to the companion device 402, such as camera images captured by a camera of the first WDD 404, input by the first user of the first WDD 404 (e.g., controller input, voice input, etc.), a state of an application running on the first WDD 404, etc.

At 414, the second WDD 406 may determine second pose information 416 and a second head motion speed 418 of the second WDD 406 (and hence the second user). In an example, the second WDD 406 may determine the second pose information 416 and the second head motion speed 418 by way of an IMU and/or a camera of the second WDD 406. The second WDD 406 may transmit the second pose information 416 and/or an indication of the second head motion speed 418 to the companion device 402. The second WDD 406 may also transmit additional information to the companion device 402, such as camera images captured by a camera of the second WDD 406, input by the second user of the second WDD 406, a state of an application running on the second WDD 406, etc.

At 420, the companion device 402 may generate a single rendered frame 422 for the first WDD 404 and the second WDD 406 independent of WDD capabilities, that is, the companion device 402 may generate the single rendered frame 422 without taking into account the first capabilities of the first WDD 404 and the second capabilities of the second WDD 406 or the companion device 402 may generate the single rendered frame 422 according to a lowest supported quality level among the first WDD 404 and the second WDD 406. As a result, the first capabilities of the first WDD 404 or the second capabilities of the second WDD 406 may be underutilized. For instance, the single rendered frame 422 may be at a 1080×1200 resolution, but the first WDD 404 may support a 1440×1600 resolution. In one aspect, the companion device 402 may generate the single rendered frame 422 based on the first pose information 410, the first head motion speed 412, the second pose information 416, and/or the second head motion speed 418. In one aspect, the companion device 402 may generate the single rendered frame 422 based on the additional information transmitted by the first WDD 404 and the second WDD 406. The companion device 402 may transmit the single rendered frame 422 to the first WDD 404 and the second WDD 406.

At 424, the first WDD 404 may perform a late stage reprojection (LSR) on the single rendered frame 422. LSR may refer to a WDD warping rendered frames (i.e., rendered content) received from a companion device based on latest available pose information at the WDD. LSR may also be referred to as reprojection or asynchronous reprojection. Reprojection may account for a change in location/orientation of the WDD between a time at which a frame is rendered at the companion device and a time at which the rendered frame is received at the WDD. LSR may be performed by executing LSR algorithms such as asynchronous reprojection, asynchronous timewarp, asynchronous spacewarp, and motion smoothing. For instance, the first WDD 404 may perform the LSR based on current pose information of the first WDD 404. At 426, the second WDD 406 may perform a LSR on the single rendered frame 422. For instance, the second WDD 406 may perform a LSR based on current pose information of the second WDD 406. At 428, based on performing the LSR, the first WDD 404 may display the single rendered frame 422 on display panel(s) of the first WDD 404. At 430, based on performing the LSR, the second WDD 406 may display the single rendered frame 422 on display panel(s) of the second WDD 406.

In split XR systems, an HMD (e.g., XR glasses) may offload computationally intensive tasks to a companion device in order to reduce power dissipation at the HMD. In a multiple-user scenario, there may be a case where a single companion is linked to and renders frames for multiple HMDs. The multiple HMDs may have different capabilities in terms of a display pipeline (e.g., different frame sizes, different frames per second (FPS) supported, etc.). The multiple HMDs may also have different capabilities in terms of wireless local area network (WLAN) characteristics. For instance, different HMDs may be in higher or lower overlapping basic service sets (OBSS). OBSS may refer to two basic service sets (BSSs) that overlap due to channel configurations occupying some of the same space. To support multiple users, the companion device may render a single identical frame (e.g., the single rendered frame 422) for all HMDs (e.g., the first WDD 404 and the second WDD 406), where each individual HMD may perform a LSR based on a local head pose. However, in this scenario, the companion device may render at a lowest capability point of all HMDs in the split XR systems. This may lead to HMDs with higher capabilities being restricted by a lowest capable HMD in the split XR system. For instance, a first HMD may be capable of presenting content at 120 frames per second (FPS) and a second HMD may be capable of presenting content at 90 FPS. In order to support both the first HMD and the second HMD, the companion device may render content at 90 FPS, which may lead to processing power of the first HMD being underutilized.

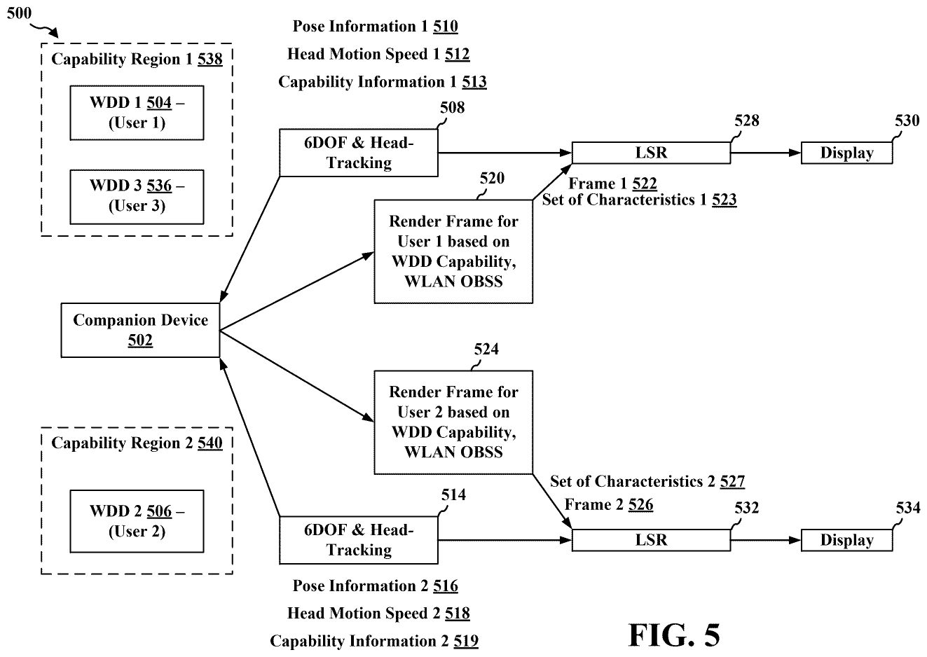

FIG. 5 is a diagram 500 illustrating an example multiple user split XR system in accordance with one or more techniques of this disclosure. The multiple user split XR system may include a companion device 502, a first WDD 504 worn by a first user, and a second WDD 506 worn by a second user. The first WDD 504 and the second WDD 506 may have first capabilities and second capabilities, respectively. For example, the first capabilities may include a first resolution of the first WDD 504, a first refresh rate of the first WDD 504, a first frame rate of the first WDD 504, and/or a first display size of a display of the first WDD 504 and the second capabilities may include a second resolution of the second WDD 506, a second refresh rate of the second WDD 506, a second frame rate of the second WDD 506, and/or a second display size of a display of the second WDD 506. The first capabilities and the second capabilities may be different. For instance, the first refresh rate of the first WDD 504 may be 120 Hz and the second refresh rate of the second WDD 506 may be 90 Hz.

The companion device 502 may be or include phone(s), such as smartphone(s), tablet(s), desktop computing device(s), laptop computing device(s), server(s), such as cloud servers, and/or gaming console(s). The companion device 502 may alternatively be referred to as a remote device, a companion, or a host. In an example, the first WDD 504 may be a first HMD or first XR glasses and the second WDD 506 may be a second HMD or second XR glasses. The first WDD 504 and the second WDD 506 may also be referred to as headsets. The companion device may be connected to the first WDD 504 and the second WDD 506 by wired connection(s) (e.g., universal serial bus (USB)) or wireless connection(s) (e.g., wireless local area network, 5G New Radio (NR), another cellular technology, etc.). In an example, the companion device 502 may be the device 104. In another example, the first WDD 504 may be the device 104. In yet another example, the second WDD 506 may be the device 104. Although the following description below focuses on two WDDs, the concepts presented below may be applicable to any number of WDDs (e.g., N wearable display devices, where N is a positive integer).

In general, the companion device 502 may be configured to render XR content and transmit the XR content to the first WDD 504 and the second WDD 506. In general, the first WDD 504 and the second WDD 506 may be configured to receive the rendered XR content, process the rendered XR content (explained in greater detail below), and present the processed rendered XR content on display(s). In one aspect, a WDD (e.g., the first WDD 504, the second WDD 506, etc.) may include a first display and a second display. When the WDD is worn by a user, the first display and the second display may be located within a certain distance (e.g., within several centimeters) of a first eye of the user and a second eye of the user, respectively. The WDD may present first processed rendered content on the first display concurrently (or nearly concurrently) with presenting second processed rendered content on the second display, where the first processed rendered content may be viewed by the first eye and the second processed rendered content may be viewed by the second eye. In an example, when viewed by the user, the first processed rendered content and the second processed rendered content may be perceived to be an object present in an environment of the user.

At 508, the first WDD 504 may determine first pose information 510 and a first head motion speed 512 of the first WDD 504 (and hence the first user). As used herein, pose information may refer to a current location (e.g., an xyz coordinate) and an orientation (e.g., a roll, a pitch, and a yaw) of a WDD (and hence, a head of a user of the WDD). Pose information may be alternatively referred to as a 6 degree-of-freedom pose (6DOF). As used herein, head motion speed may refer to a speed of a head of a user while the user wears a WDD. Determining a head motion speed may also be referred to as head-tracking. In an example, the first WDD 504 may determine the first pose information 510 and the first head motion speed 512 by way of an inertial measurement unit (IMU) and/or a camera of the first WDD 504. The first WDD 504 may transmit the first pose information 510 and/or an indication of the first head motion speed 512 to the companion device 502. The first WDD 504 may also transmit additional information to the companion device 502, such as camera images captured by a camera of the first WDD 504, input by the first user of the first WDD 504 (e.g., controller input, voice input, etc.), a state of an application running on the first WDD 504, etc.

At 514, the second WDD 506 may determine second pose information 516 and a second head motion speed 518 of the second WDD 506 (and hence the second user). In an example, the second WDD 506 may determine the second pose information 516 and the second head motion speed 518 by way of an IMU and/or a camera of the second WDD 506. The second WDD 506 may transmit the second pose information 516 and/or an indication of the second head motion speed 518 to the companion device 502. The second WDD 506 may also transmit additional information to the companion device 502, such as camera images captured by a camera of the second WDD 506, input by the second user of the second WDD 506, a state of an application running on the second WDD 506, etc.

The first WDD 504 may also transmit first capability information 513 of the first WDD 504 to the companion device 502. The first capability information 513 may indicate a first refresh rate supported by the first WDD 504, a first frame rate supported by the first WDD 504, a first display size of a display of the first WDD 504, first WLAN interference conditions (e.g., overlapping basic service sets (OBSS)) of the first WDD 504, and/or other types of graphics and/or display features supported by the first WDD 504 (e.g., types of supported antialiasing supported). The second WDD 506 may also transmit second capability information 519 of the first WDD 504 to the companion device 502. The second capability information 519 may indicate a second refresh rate supported by the second WDD 506, a second frame rate supported by the second WDD 506, a second display size of a display of the second WDD 506, second WLAN interference conditions (e.g., OBSS) of the second WDD 506, and/or other types of graphics and/or display features supported by the second WDD 506 (e.g., types of supported antialiasing supported).

At 520, the companion device 502 may render a first frame 522 for the first WDD 504 based on the first capability information 513. The companion device 502 may also render the first frame 522 based on the first pose information 510, the first head motion speed 512, and/or the additional information transmitted by the first WDD 504. The first frame 522 may be associated with a first set of characteristics 523 (e.g., a first resolution, a first refresh rate, a first display size, first WLAN interference characteristics, etc.). At 524, the companion device 502 may render a second frame 526 for the second WDD 506 based on the second capability information 519. The companion device 502 may also render the second frame 526 based on the second pose information 516, the second head motion speed 518, and/or the additional information transmitted by the second WDD 506. The second frame 526 may be associated with a second set of characteristics 527 (e.g., a second resolution, a second refresh rate, a second display size, second WLAN interference characteristics, etc.). The first frame 522 may be tailored for the first WDD 504 and the second frame 526 may be tailored for the second WDD 506 based on the first capability information 513 and the second capability information 519, respectively. In an example, the first WDD 504 may support a first resolution (e.g., 1400×1600 pixels) and as a result, the companion device 502 may render the first frame 522 at the first resolution, whereas the second WDD 506 may support a second resolution (e.g., 1080×1200 pixels), and as a result, the companion device 502 may render the second frame 526 at the second resolution. In a more specific example, the first frame 522 and the second frame 526 may both display the same object, but at different resolutions. The companion device 502 may transmit the first frame 522 to the first WDD 504. The companion device 502 may transmit the second frame 526 to the second WDD 506.

Upon receiving the first frame 522, at 528, the first WDD 504 may perform a LSR on the first frame 522 based on latest available pose information of the first WDD 504. At 530, based on performing the LSR, the first WDD 504 may display the first frame 522 on display panel(s) of the first WDD 504. Upon receiving the second frame 526, at 532, the second WDD 506 may perform a LSR on the second frame 526 based on latest available pose information of the second WDD 506. At 534, based on performing the LSR, the second WDD 506 may display the second frame 526 on display panel(s) of the second WDD 506. Thus, in comparison to the multiple user split XR system described in FIG. 4, the multiple user split XR system described in FIG. 5 may provide for a more customized experience for different users that may take advantage of different capabilities of different WDDs.

In one aspect, at the beginning of an XR session, there may be a negotiation between a companion device (e.g., the companion device 502) and an HMD (e.g., the first WDD 504, the second WDD 506, etc.). Based on capabilities of the HMD (e.g., the first capability information 513, the second capability information 519, etc.) and/or capabilities of the companion device, session configuration parameters may be set.

In one aspect, a companion device (e.g., the companion device 502) may render frames at varying quality levels for different HMDs (e.g., the first WDD 504, the second WDD 506, etc.) in terms of video resolution, display size, refresh rate, and WLAN interference conditions based on separate link(s) between the companion device and HMD(s).

In one aspect, a companion device (e.g., the companion device 502) may use a mipmapping technique for generating frames (e.g., the first frame 522, the second frame 526, etc.) at multiple spatial resolution levels. Mipmapping may refer to a technique where a high-resolution texture is downscaled and filtered so that each subsequent multum in parvo (mip) (i.e., much in little) level is a quarter of the area of the previous level. The companion device may use spatial scalable video encoding to send bitstream(s) over a WLAN link, where each bitstream may be for a different HMD. Spatial scalable video encoding may refer to encoding performed using multiple spatial resolutions.

In one aspect, a companion device (e.g., the companion device 502) may use temporal scalable video encoding to achieve different quality levels for rendered frames (e.g., the first frame 522, the second frame 526). Temporal scalable video encoding may refer to encoding performed by dropping packets of a bitstream in order to reduce a frame rate.

In one aspect, the companion device 502 may generate a frame. The companion device 502 may scale the frame in different manners (e.g., based on the first capability information 513 and the second capability information 519) to generate the first frame 522 and the second frame 526. The first frame 522 and the second frame 526 may be reprojected at the first WDD 504 and the second WDD 506, respectively.

In one aspect, the first frame 522 and the second frame 526 may include the same content, but with different characteristics. For instance, the first frame 522 and the second frame 526 may each include an object (e.g., a tree). However, the object (e.g., the tree) in the first frame 522 may be displayed at a first resolution and the tree in the second frame 526 may be displayed at a second resolution that is different than the first resolution.

In one aspect, a companion device (e.g., the companion device 502) may distribute HMDs (e.g., the first WDD 504, the second WDD 506, etc.) into different (e.g., a few) capability regions to reduce a number of rendering levels if the companion device 502 is unable to support different quality levels for each HMD or if some HMDs have similar quality expectations. A capability region may refer to a group of WDDs/HMDs that have the same or similar capabilities. For example, a third WDD 536 may have capabilities that are similar to or identical to capabilities of the first WDD 504. The companion device 502 may assign the first WDD 504 and the third WDD 536 to a first capability region 538 (i.e., a first capability group) based on their respective capabilities being similar or identical (i.e., the first WDD 504 and the third WDD 536 may share the first capability information 513). The companion device 502 may assign the second WDD 506 to a second capability region 540 (i.e., a second capability group). The companion device 502 may transmit the first frame 522 to each member of a capability region, that is, the companion device 502 may transmit the first frame 522 to the first WDD 504 and the third WDD.

In one aspect, HMDs (e.g., the first WDD 504, the second WDD 506, etc.) may send an indication of (i.e., vote for) a higher or lower quality level based on their respective battery lives. A companion device (e.g., the companion device 502) may allocate an HMD to a different capability region (e.g., the first capability region 538, the second capability region 540, etc.) based on a vote (i.e., based on a request from the HMD). A “vote” may refer to an indication of a choice or selection for a course of action. For instance, a vote may indicate that one action is more suitable or desirable compared to another action. For example, a vote for a lower quality level from a device may be an indication that a lower quality level is more suitable or desirable based on the battery life of the device.

In one aspect, HMDs (e.g., the first WDD 504, the second WDD 506, etc.) may vote on a minimum quality and an expected quality of content (i.e., frames) that the HMDs request. A companion device (e.g., the companion device 502) may reduce a quality of content to a minimum quality (e.g., a lowest supported quality) if more HMDs join the split XR system (e.g., a number of HMDs join that is greater than a threshold) or if a battery level of the companion device is low (e.g., the battery level is less than a threshold).

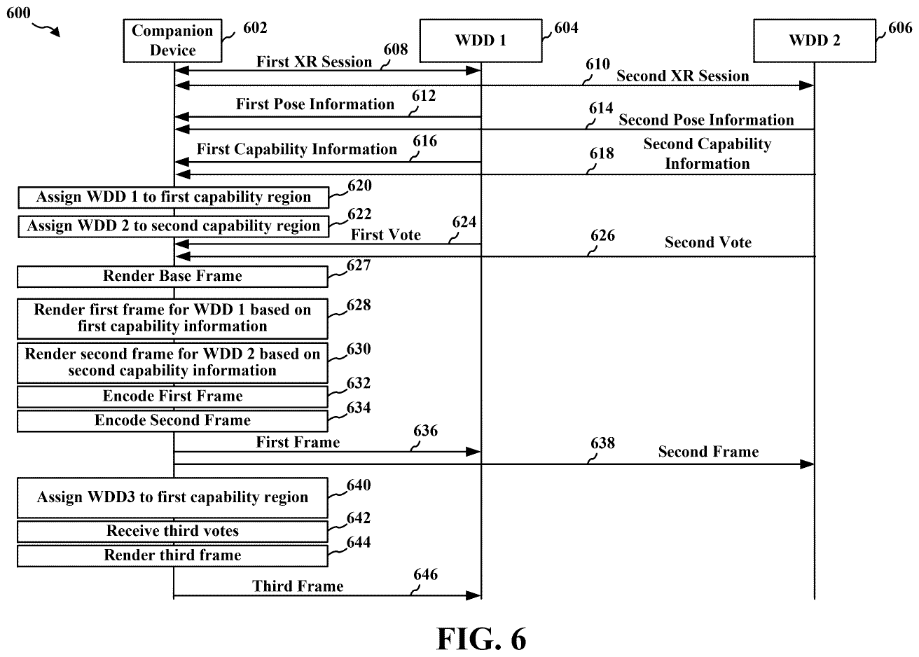

FIG. 6 is a call flow diagram 600 illustrating example communications between a companion device 602, and a first wearable display device 604 (referred to in FIG. 6 as “WDD 1”), and a second wearable display device 606 (referred to in FIG. 6 as “WDD 2”) in accordance with one or more techniques of this disclosure. In an example, the companion device 602 may be or include the companion device 502, the first wearable display device 604 may be or include the first WDD 504, and/or the second wearable display device 606 may be or include the second WDD 506.

At 608 and 610, the companion device 602 may establish a first extended reality (XR) session with the first wearable display device 604 and a second XR session with the second wearable display device 606, respectively. At 612 and 614, the companion device 602 may obtain first pose information of the first wearable display device 604 and second pose information of the second wearable display device 606. At 616 and 618, the companion device 602 may obtain first capability information for a first wearable display device 604 and second capability information for a second wearable display device 606, respectively. At 620, the companion device 602 may assign, based on the first capability information, the first wearable display device 604 to a first capability region including a first set of wearable display devices. At 622, the companion device 602 may assign, based on the second capability information, the second wearable display device 606 to a second capability region including a second set of wearable display devices.

At 624, the companion device 602 may receive a first set of votes from each of the first set of wearable display devices (e.g., from the first wearable display device 604), where each of the first set of votes is indicative of a first requested quality level of the first frame. At 626, the companion device 602 may receive a second set of votes from each of the second set of wearable display devices (e.g., from the second wearable display device 606), where each of the second set of votes is indicative of a second requested quality level of the second frame.

In one aspect, at 627, the companion device 602 may render a base frame. At 628, the companion device 602 may render, based on the first capability information, a first frame for the first wearable display device 604, where the first frame is associated with a first set of characteristics. In one aspect, the companion device 602 may render the first frame based on the base frame and the first capability information. At 630, the companion device 602 may render, based on the second capability information, a second frame for the second wearable display device 606, where the second frame is associated with a second set of characteristics. In one aspect, the companion device 602 may render the second frame based on the base frame and the second capability information. At 632, the companion device 602 may encode the first frame. At 634, the companion device 602 may encode the second frame. At 636 and 638, the companion device 602 may transmit the rendered first frame for the first wearable display device 604 and the rendered second frame for the second wearable display device 606, respectively. At 640, the companion device 602 may assign, based on the rendering of the first frame, a third wearable display device to the first capability region based on third capability information of the third wearable display device. At 642, the companion device 602 may receive a third set of votes from each wearable display device in the first capability region, where each of the third set of votes is indicative of a third requested quality level. At 644, the companion device 602 may render a third frame at a second quality level based on the third set of votes. At 646, the companion device 602 may transmit, for the first wearable display device 604 and the third wearable display device, the third frame.

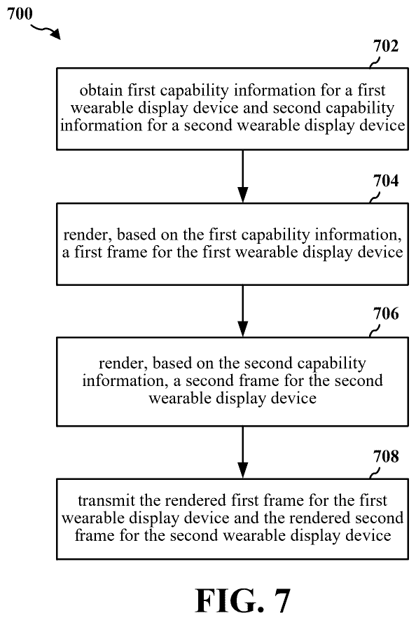

FIG. 7 is a flowchart 700 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-6. In an example, the method may be performed by the device 104, the companion device 502, or the companion device 602. In an example, the method may be performed by the multi-level renderer 198.

At 702, the apparatus (e.g., a companion device) obtains first capability information for a first wearable display device and second capability information for a second wearable display device. For example, FIG. 6 at 616 and 618 shows that the companion device 602 may obtain first capability information for a first wearable display device 604 and second capability information for a second wearable display device 606, respectively. In an example, the first wearable display device may be or include the first WDD 504 and the second wearable display device may be or include the second WDD 506. In an example, the first capability information may be or include the first capability information 513 and the second capability information may be or include the second capability information 519. In an example, 702 may be performed by the multi-level renderer 198.

At 704, the apparatus (e.g., a companion device) renders, based on the first capability information, a first frame for the first wearable display device. For example, FIG. 6 at 628 shows that the companion device 602 may render, based on the first capability information, a first frame for the first wearable display device 604. In another example, FIG. 5 at 520 shows that the companion device 502 may render, based on the first capability information, a first frame for the first wearable display device. In an example, 704 may be performed by the multi-level renderer 198.

At 706, the apparatus (e.g., a companion device) renders, based on the second capability information, a second frame for the second wearable display device. For example, FIG. 6 at 630 shows that the companion device 602 may render, based on the second capability information, a second frame for the second wearable display device 606. In another example, FIG. 5 at 520 shows that the companion device 502 may render, based on the second capability information, a second frame for the second wearable display device. In an example, 706 may be performed by the multi-level renderer 198.

At 708, the apparatus (e.g., a companion device) transmit the rendered first frame for the first wearable display device and the rendered second frame for the second wearable display device. For example, FIG. 6 at 636 and 638 shows that the companion device 602 may transmit the rendered first frame for the first wearable display device 604 and the rendered second frame for the second wearable display device 606. In an example, the rendered first frame may be or include the first frame 522 and the rendered second frame may be or include the second frame 526. In an example, 708 may be performed by the multi-level renderer 198.

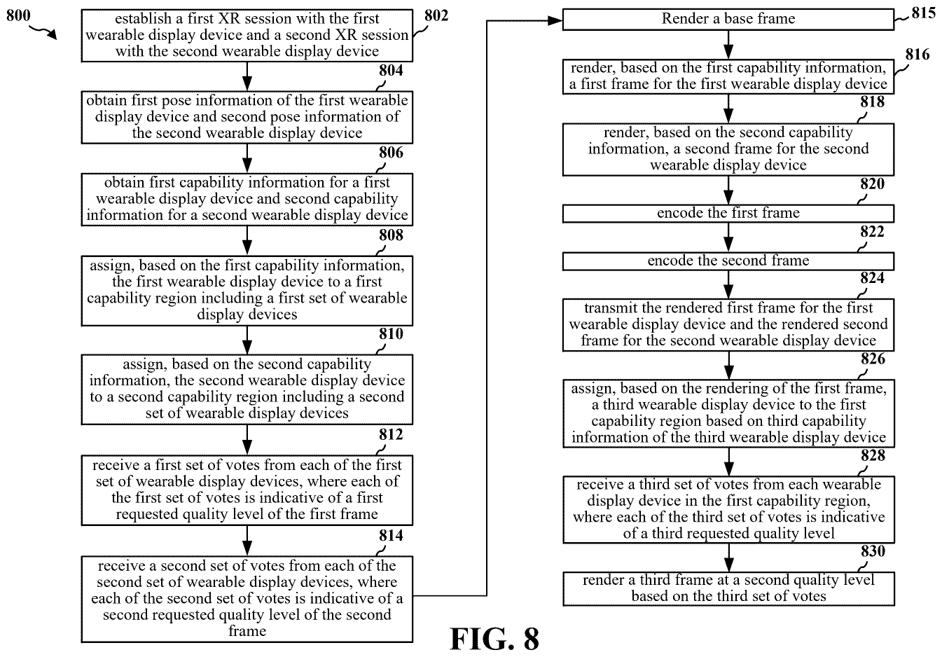

FIG. 8 is a flowchart 800 of an example method of graphics processing in accordance with one or more techniques of this disclosure. The method may be performed by an apparatus, such as an apparatus for graphics processing, a GPU, a CPU, a wireless communication device, and the like, as used in connection with the aspects of FIGS. 1-6. In an example, the method may be performed by the device 104, the companion device 502, or the companion device 602. In an example, the method (including the various aspects detailed below) may be performed by the multi-level renderer 198.

At 806, the apparatus (e.g., a companion device) obtains first capability information for a first wearable display device and second capability information for a second wearable display device. For example, FIG. 6 at 616 and 618 shows that the companion device 602 may obtain first capability information for a first wearable display device 604 and second capability information for a second wearable display device 606, respectively. In an example, the first wearable display device may be or include the first WDD 504 and the second wearable display device may be or include the second WDD 506. In an example, the first capability information may be or include the first capability information 513 and the second capability information may be or include the second capability information 519. In an example, 806 may be performed by the multi-level renderer 198.

At 815, the apparatus (e.g., a companion device) renders a base frame, where rendering the first frame comprises rendering the first frame based on the base frame and the first capability information, and where rendering the second frame comprises rendering the second frame based on the base frame and the second capability information. For example, FIG. 6 at 627 shows that the companion device 602 may render a base frame, and rendering the first frame and the second frame at 628 and 630 may be based on the base frame. In an example, 815 may be performed by the multi-level renderer 198.

In one aspect, the first frame may be associated with a first reprojection for the first wearable display device and the second frame may be associated with a second reprojection for the second wearable display device, where the second reprojection is different from the first reprojection. For example, the first reprojection may be associated with the first wearable display device 604 and the second reprojection may be associated with the second wearable display device 606.

In one aspect, rendering the first frame based on the base frame and the first capability information may include scaling the first frame according to a first scaling, and rendering the second frame based on the base frame and the second capability information may include scaling the second frame according to a second scaling that is different from the first scaling. For example, rendering the first frame at 628 may be based on a first scaling and rendering the second frame at 628 and 630 may be based on the base frame.

At 816, the apparatus (e.g., a companion device) renders, based on the first capability information, a first frame for the first wearable display device. For example, FIG. 6 at 628 shows that the companion device 602 may render, based on the first capability information, a first frame for the first wearable display device 604. In another example, FIG. 5 at 520 shows that the companion device 502 may render, based on the first capability information, a first frame for the first wearable display device. In an example, 816 may be performed by the multi-level renderer 198.

At 818, the apparatus (e.g., a companion device) renders, based on the second capability information, a second frame for the second wearable display device. For example, FIG. 6 at 630 shows that the companion device 602 may render, based on the second capability information, a second frame for the second wearable display device 606. In another example, FIG. 5 at 520 shows that the companion device 502 may render, based on the second capability information, a second frame for the second wearable display device. In an example, 818 may be performed by the multi-level renderer 198.

At 824, the apparatus (e.g., a companion device) transmit the rendered first frame for the first wearable display device and the rendered second frame for the second wearable display device. For example, FIG. 6 at 636 and 638 shows that the companion device 602 may transmit the rendered first frame for the first wearable display device 604 and the rendered second frame for the second wearable display device 606. In an example, the rendered first frame may be or include the first frame 522 and the rendered second frame may be or include the second frame 526. In an example, 824 may be performed by the multi-level renderer 198.

In one aspect, at 802, the apparatus (e.g., a companion device) may establish a first extended reality (XR) session with the first wearable display device and a second XR session with the second wearable display device, where the first capability information may be obtained during the first XR session and the second capability information is obtained during the second XR session, or where the first capability information and the second capability information may be obtained prior to the establishment of the first XR session and the second XR session, respectively. For example, FIG. 6 at 608 and 610 shows that the companion device 602 may establish a first extended reality (XR) session with the first wearable display device 604 and a second XR session with the second wearable display device 606, where the first capability information may be obtained during the first XR session and the second capability information is obtained during the second XR session, or where the first capability information and the second capability information may be obtained prior to the establishment of the first XR session and the second XR session, respectively. In an example, 802 may be performed by the multi-level renderer 198.

In one aspect, the first capability information may include at least one of a first resolution of the first wearable display device, a first refresh rate of the first wearable display device, or a first display size of the first wearable display device, and where the second set of characteristics may include at least one of a second resolution of the second wearable display device, a second refresh rate of the second wearable display device, or a second display size of the second wearable display device. For example, the first capability information 513 may include at least one of a first resolution of the first wearable display device, a first refresh rate of the first wearable display device, or a first display size of the first wearable display device and the second capability information 519 may include at least one of a second resolution of the second wearable display device, a second refresh rate of the second wearable display device, or a second display size of the second wearable display device.

In one aspect, the first capability information may include first wireless local area network (WLAN) interference conditions of a first link between the first wearable display device and a companion device, and where the second capability information may include second WLAN interference conditions of a second link between with the second wearable display device and the companion device. For example, the first capability information 513 may include first wireless local area network (WLAN) interference conditions of a first link between the first wearable display device and a companion device and the second capability information 519 may include second WLAN interference conditions of a second link between with the second wearable display device and the companion device.

In one aspect, rendering the first frame and rendering the second frame may include: rendering, based on a mipmapping technique, a set of frames, where each frame in the set of frames may correspond to a different resolution compared to other frames in the set of frames, and where the set of frames may include the first frame and the second frame. For example, rendering the first frame and the second frame at 628 and 630, respectively, may include rendering, based on a mipmapping technique, a set of frames, where each frame in the set of frames may correspond to a different resolution compared to other frames in the set of frames, and where the set of frames may include the first frame and the second frame.

In one aspect, at 820, the apparatus (e.g., a companion device) may encode the first frame. For example, FIG. 6 at 632 shows that the companion device 602 may encode the first frame. In an example, 820 may be performed by the multi-level renderer 198.

In one aspect, at 822, the apparatus (e.g., a companion device) may encode the second frame, where transmitting the first frame and the second frame may include transmitting the encoded first frame and the encoded second frame. For example, FIG. 6 at 634 shows that the companion device 602 may encode the second frame. In an example, 822 may be performed by the multi-level renderer 198.

In one aspect, encoding the first frame may include performing a first spatial scalable video encoding on the first frame, and where encoding the second frame may include performing a second spatial scalable video encoding on the second frame. For example, encoding the first frame at 632 may include performing a first spatial scalable video encoding on the first frame and encoding the second frame at 634 may include performing a second spatial scalable video encoding on the second frame.

In one aspect, encoding the first frame may include performing a first temporal scalable video encoding on the first frame, and where encoding the second frame may include performing a second temporal scalable video encoding on the second frame. For example, encoding the first frame at 632 may include performing a first temporal scalable video encoding on the first frame and encoding the second frame at 634 may include performing a second temporal scalable video encoding on the second frame.

In one aspect, at 808, the apparatus (e.g., a companion device) may assign, based on the first capability information, the first wearable display device to a first capability region including a first set of wearable display devices, where rendering the first frame may be based on the assignment of the first wearable display device to the first capability region. For example, FIG. 6 at 620 shows that the companion device 602 may assign, based on the first capability information, the first wearable display device 604 to a first capability region including a first set of wearable display devices, where rendering the first frame may be based on the assignment of the first wearable display device 604 to the first capability region. In an example, the first capability region may be or include the first capability region 538. In an example, the first set of wearable display devices may include the first WDD 504. In an example, 808 may be performed by the multi-level renderer 198.

In one aspect, at 810, the apparatus (e.g., a companion device) may assign, based on the second capability information, the second wearable display device to a second capability region including a second set of wearable display devices, where rendering the second frame may be based on the assignment of the second wearable display device to the second capability region. For example, FIG. 6 at 622 shows that the companion device 602 may assign, based on the second capability information, the second wearable display device 606 to a second capability region including a second set of wearable display devices, where rendering the second frame may be based on the assignment of the second wearable display device 606 to the second capability region. In an example, the second capability region may be or include the second capability region 540. In an example, the second set of wearable display devices may include the second WDD 506. In an example, 810 may be performed by the multi-level renderer 198.

In one aspect, the first set of wearable display devices may be associated with the first set of characteristics, and where the second set of wearable display devices may be associated with the second set of characteristics. For example, the first set of wearable display devices may be associated with the first set of characteristics 523 and the second set of wearable display devices may be associated with the second set of characteristics 527.

In one aspect, at 812, the apparatus (e.g., a companion device) may receive a first set of votes from each of the first set of wearable display devices, where each of the first set of votes may be indicative of a first requested quality level of the first frame, where rendering the first frame may be based on the first set of votes. For example, FIG. 6 at 624 shows that the companion device 602 may receive a first set of votes from each of the first set of wearable display devices, where each of the first set of votes may be indicative of a first requested quality level of the first frame, where rendering the first frame may be based on the first set of votes. In an example, 812 may be performed by the multi-level renderer 198.

In one aspect, at 814, the apparatus (e.g., a companion device) may receive a second set of votes from each of the second set of wearable display devices, where each of the second set of votes may be indicative of a second requested quality level of the second frame, where rendering the second frame may be based on the second set of votes. For example, FIG. 6 at 626 shows that the companion device 602 may receive a second set of votes from each of the second set of wearable display devices, where each of the second set of votes may be indicative of a second requested quality level of the second frame, where rendering the second frame may be based on the second set of votes. In an example, 814 may be performed by the multi-level renderer 198.

In one aspect, each of the first set of votes may be based on a first battery level of each of the first set of wearable display devices, where each of the second set of votes may be based on a second battery level of each of the second set of wearable display devices. For example, the first set of votes received at 624 may be based on a first battery level of each of the first set of wearable display devices, and the second set of votes received at 626 may be based on a second battery level of each of the second set of wearable display devices.

In one aspect, the first set of votes may be indicative of a first minimum quality level of the first frame, and where the second set of votes may be indicative of a second minimum quality level of the second frame. For example, the first set of votes received at 624 may be indicative of a first minimum quality level of the first frame and the second set of votes received at 626 may be indicative of a second minimum quality level of the second frame.

In one aspect, the first frame may be rendered at a first quality level, and at 826, the apparatus (e.g., a companion device) may assign, based on the rendering of the first frame, a third wearable display device to the first capability region based on third capability information of the third wearable display device. For example, the first frame rendered at 628 may be rendered at a first quality level. Furthermore, FIG. 6 at 640 shows that the companion device may assign, based on the rendering of the first frame, a third wearable display device to the first capability region based on third capability information of the third wearable display device. In an example, the third wearable display device may be or include the third WDD 536. In an example, 826 may be performed by the multi-level renderer 198.

In one aspect, the first frame may be rendered at a first quality level, and at 828, the apparatus (e.g., a companion device) may receive a third set of votes from each wearable display device in the first capability region, where each of the third set of votes is indicative of a third requested quality level. For example, FIG. 6 at 642 shows that the companion device 602 may receive a third set of votes from each wearable display device in the first capability region, where each of the third set of votes is indicative of a third requested quality level. In an example, 828 may be performed by the multi-level renderer 198.

In one aspect, the first frame may be rendered at a first quality level, and at 830, the apparatus (e.g., a companion device) may render a third frame at a second quality level based on the third set of votes. For example, FIG. 6 at 644 shows that the companion device 602 may render a third frame at a second quality level based on the third set of votes. In an example, 830 may be performed by the multi-level renderer 198.

In one aspect, rendering the first frame may be further based on a battery level of a companion device, and rendering the second frame may be further based on the battery level of the companion device. For example, rendering the first frame at 628 may be further based on a battery level of the companion device 602, and rendering the second frame at 630 may be further based on the battery level of the companion device 602.

In one aspect, at 804, the apparatus (e.g., a companion device) may obtain first pose information of the first wearable display device and second pose information of the second wearable display device, where rendering the first frame may be further based on the first pose information, and where rendering the second frame may be further based on the second pose information. For example, FIG. 6 at 612 and 614 shows that the companion device 602 may obtain first pose information of the first wearable display device 604 and second pose information of the second wearable display device 606, where rendering the first frame may be further based on the first pose information, and where rendering the second frame may be further based on the second pose information. In an example, the first pose information may be or include the first pose information 510. The first post information may also include the first head motion speed 512. In an example, the second pose information may be or include the second pose information 516. The second post information may also include the second head motion speed 518. In an example, 804 may be performed by the multi-level renderer 198.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus (e.g., processing unit 120 within the device 104) may include means for obtaining first capability information for a first wearable display device and second capability information for a second wearable display device. The apparatus (e.g., processing unit 120 within the device 104) may further include means for rendering, based on the first capability information, a first frame for the first wearable display device. The apparatus (e.g., processing unit 120 within the device 104) may further include means for rendering, based on the second capability information, a second frame for the second wearable display device. The apparatus (e.g., processing unit 120 within the device 104) may further include means for transmitting the rendered first frame for the first wearable display device and the rendered second frame for the second wearable display device. The apparatus (e.g., processing unit 120 within the device 104) may further include means for establishing a first extended reality (XR) session with the first wearable display device and a second XR session with the second wearable display device, where the first capability information is obtained during the first XR session and the second capability information is obtained during the second XR session, or prior to the establishment of the first XR session and the second XR session, respectively. The apparatus (e.g., processing unit 120 within the device 104) may further include means for encoding the first frame. The apparatus (e.g., processing unit 120 within the device 104) may further include means for encoding the second frame, where transmitting the first frame and the second frame includes transmitting the encoded first frame and the encoded second frame. The apparatus (e.g., processing unit 120 within the device 104) may further include means for assigning, based on the first capability information, the first wearable display device to a first capability region including a first set of wearable display devices, where rendering the first frame is based on the assignment of the first wearable display device to the first capability region. The apparatus (e.g., processing unit 120 within the device 104) may further include means for assigning, based on the second capability information, the second wearable display device to a second capability region including a second set of wearable display devices, where rendering the second frame is based on the assignment of the second wearable display device to the second capability region. The apparatus (e.g., processing unit 120 within the device 104) may further include means for receiving a first set of votes from each of the first set of wearable display devices, where each of the first set of votes is indicative of a first requested quality level of the first frame, where rendering the first frame is based on the first set of votes. The apparatus (e.g., processing unit 120 within the device 104) may further include means for receiving a second set of votes from each of the second set of wearable display devices, where each of the second set of votes is indicative of a second requested quality level of the second frame, where rendering the second frame is based on the second set of votes. The apparatus (e.g., processing unit 120 within the device 104) may further include means for assigning, based on the rendering of the first frame, a third wearable display device to the first capability region based on third capability information of the third wearable display device. The apparatus (e.g., processing unit 120 within the device 104) may further include means for receiving a third set of votes from each wearable display device in the first capability region, where each of the third set of votes is indicative of a third requested quality level. The apparatus (e.g., processing unit 120 within the device 104) may further include means for rendering a third frame at a second quality level based on the third set of votes. The apparatus (e.g., processing unit 120 within the device 104) may further include means for obtaining first pose information of the first wearable display device and second pose information of the second wearable display device, where rendering the first frame is further based on the first pose information, and where rendering the second frame is further based on the second pose information. The apparatus (e.g., processing unit 120 within the device 104) may further include means for rendering a base frame, where rendering the first frame is based on the base frame and the first capability information, and where rendering the second frame is based on the base frame and the second capability information.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: obtaining first capability information for a first wearable display device and second capability information for a second wearable display device; rendering, based on the first capability information, a first frame for the first wearable display device; rendering, based on the second capability information, a second frame for the second wearable display device; and transmitting the rendered first frame for the first wearable display device and the rendered second frame for the second wearable display device.

Aspect 2 is the method of aspect 1, further comprising: establishing a first extended reality (XR) session with the first wearable display device and a second XR session with the second wearable display device, wherein the first capability information is obtained during the first XR session and the second capability information is obtained during the second XR session, or prior to the establishment of the first XR session and the second XR session, respectively.

Aspect 3 is the method of any of aspects 1-2 and comprises that the first capability information includes at least one of a first resolution of the first wearable display device, a first refresh rate of the first wearable display device, or a first display size of the first wearable display device, and wherein the second capability information includes at least one of a second resolution of the second wearable display device, a second refresh rate of the second wearable display device, or a second display size of the second wearable display device.

Aspect 4 is the method of any of aspects 1-3 and comprises that the first capability information includes first wireless local area network (WLAN) interference conditions of a first link between the first wearable display device and a companion device, and wherein the second capability information includes second WLAN interference conditions of a second link between with the second wearable display device and the companion device.

Aspect 5 is the method of any of aspects 1-4 and comprises that rendering the first frame and rendering the second frame includes: rendering, based on a mipmapping technique, a set of frames, wherein each frame in the set of frames corresponds to a different resolution compared to other frames in the set of frames, and wherein the set of frames includes the first frame and the second frame.

Aspect 6 is the method of aspect 5, further comprising: encoding the first frame; and encoding the second frame, wherein transmitting the first frame and the second frame includes transmitting the encoded first frame and the encoded second frame.

Aspect 7 is the method of aspect 6 and comprises that encoding the first frame includes performing a first spatial scalable video encoding on the first frame, and wherein encoding the second frame includes performing a second spatial scalable video encoding on the second frame.

Aspect 8 is the method of aspect 6 and comprises that encoding the first frame includes performing a first temporal scalable video encoding on the first frame, and wherein encoding the second frame includes performing a second temporal scalable video encoding on the second frame.

Aspect 9 is the method of any of aspects 1-8, further comprising: assigning, based on the first capability information, the first wearable display device to a first capability region including a first set of wearable display devices, wherein rendering the first frame is based on the assignment of the first wearable display device to the first capability region; and assigning, based on the second capability information, the second wearable display device to a second capability region including a second set of wearable display devices, wherein rendering the second frame is based on the assignment of the second wearable display device to the second capability region.

Aspect 10 is the method of aspect 9 and comprises that the first set of wearable display devices is associated with the first set of characteristics, and wherein the second set of wearable display devices is associated with the second set of characteristics.

Aspect 11 is the method of any of aspects 9-10, further comprising: receiving a first set of votes from each of the first set of wearable display devices, wherein each of the first set of votes is indicative of a first requested quality level of the first frame, wherein rendering the first frame is based on the first set of votes; and receiving a second set of votes from each of the second set of wearable display devices, wherein each of the second set of votes is indicative of a second requested quality level of the second frame, wherein rendering the second frame is based on the second set of votes.

Aspect 12 is the method of any of aspects 9-11 and comprises that each of the first set of votes is based on a first battery level of each of the first set of wearable display devices, wherein each of the second set of votes is based on a second battery level of each of the second set of wearable display devices.

Aspect 13 is the method of any of aspects 9-12 and comprises that the first set of votes is indicative of a first minimum quality level of the first frame, and wherein the second set of votes is indicative of a second minimum quality level of the second frame.

Aspect 14 is the method of any of aspects 9-13 and comprises that the first frame is rendered at a first quality level, the method further including: assigning, based on the rendering of the first frame, a third wearable display device to the first capability region based on third capability information of the third wearable display device; receiving a third set of votes from each wearable display device in the first capability region, wherein each of the third set of votes is indicative of a third requested quality level; and rendering a third frame at a second quality level based on the third set of votes.

Aspect 15 is the method of any of aspects 1-14 and comprises that rendering the first frame is further based on a battery level of a companion device, and wherein rendering the second frame is further based on the battery level of the companion device.

Aspect 16 is the method of any of aspects 1-15, further comprising: obtaining first pose information of the first wearable display device and second pose information of the second wearable display device, wherein rendering the first frame is further based on the first pose information, and wherein rendering the second frame is further based on the second pose information.

Aspect 17 is the method of any of aspects 1-16, further comprising rendering a base frame, wherein rendering the first frame is based on the base frame and the first capability information, and wherein rendering the second frame is based on the base frame and the second capability information.

Aspect 18 is the method of aspect 17, wherein rendering the first frame based on the base frame and the first capability information comprises rendering the first frame according to a first scaling, and wherein rendering the second frame based on the base frame and second capability information comprises scaling the second frame according to a second scaling that is different from the first scaling.

Aspect 19 is the method of any of aspects 1-18, wherein the first frame is associated with a first reprojection for the first wearable display device, wherein the second frame is associated with a second reprojection for the second wearable display device, and wherein the second reprojection is different from the first reprojection.

Aspect 20 is an apparatus for graphics processing comprising a processor coupled to a memory and, based on information stored in the memory, the processor is configured to implement a method as in any of aspects 1-19.

Aspect 21 may be combined with aspect 20 and comprises that the apparatus is a wireless communication device comprising at least one of a transceiver or an antenna coupled to the processor, wherein to transmit the first rendered frame and the second rendered frame, the processor is configured to transmit the first rendered frame and the second rendered frame via at least one of the transceiver or the antenna.

Aspect 22 is an apparatus for graphics processing including means for implementing a method as in any of aspects 1-19.

Aspect 23 is a computer-readable medium (e.g., a non-transitory computer-readable medium) storing computer executable code, the computer executable code when executed by a processor causes the processor to implement a method as in any of aspects 1-19.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
obtain first capability information for a first wearable display device and second capability information for a second wearable display device;
render, based on the first capability information, a first frame for the first wearable display device;
render, based on the second capability information, a second frame for the second wearable display device; and
transmit the rendered first frame for the first wearable display device and the rendered second frame for the second wearable display device.

2. The apparatus of claim 1, wherein the processor is further configured to:
establish a first extended reality (XR) session with the first wearable display device and a second XR session with the second wearable display device, wherein to obtain the first capability information and the second capability information, the processor is configured to obtain the first capability information and the second capability information during the first XR session and the second XR session, respectively or prior to the establishment of the first XR session and the second XR session, respectively.

3. The apparatus of claim 1, wherein the first capability information includes at least one of a first resolution of the first wearable display device, a first refresh rate of the first wearable display device, or a first display size of the first wearable display device, and wherein the second capability information includes at least one of a second resolution of the second wearable display device, a second refresh rate of the second wearable display device, or a second display size of the second wearable display device.

4. The apparatus of claim 1, wherein the first capability information includes first wireless local area network (WLAN) interference conditions of a first link between the first wearable display device and a companion device, and wherein the second capability information includes second WLAN interference conditions of a second link between with the second wearable display device and the companion device.

5. The apparatus of claim 1, wherein to render the first frame and to render the second frame, the processor is configured to:
render, based on a mipmapping technique, a set of frames, wherein each frame in the set of frames corresponds to a different resolution compared to other frames in the set of frames, and wherein the set of frames includes the first frame and the second frame;
encode the first frame; and
encode the second frame, wherein to transmit the first frame and to transmit the second frame, the processor is configured to transmit the encoded first frame and the encoded second frame.

6. The apparatus of claim 5, wherein to encode the first frame, the processor is configured to perform a first spatial scalable video encoding on the first frame, and wherein to encode the second frame, the processor is configured to perform a second spatial scalable video encoding on the second frame.

7. The apparatus of claim 5, wherein to encode the first frame, the processor is configured to perform a first temporal scalable video encoding on the first frame, and wherein to encode the second frame, the processor is configured to perform a second temporal scalable video encoding on the second frame.

8. The apparatus of claim 1, wherein the processor is further configured to:
assign, based on the first capability information, the first wearable display device to a first capability region including a first set of wearable display devices, wherein to render the first frame, the processor is configured to render the first frame based on the assignment of the first wearable display device to the first capability region; and
assign, based on the second capability information, the second wearable display device to a second capability region including a second set of wearable display devices, wherein to render the second frame, the processor is configured to render the second frame based on the assignment of the second wearable display device to the second capability region.

9. The apparatus of claim 8, wherein the first set of wearable display devices is associated with the first capability information, and wherein the second set of wearable display devices is associated with the second capability information.

10. The apparatus of claim 8, wherein the processor is further configured to:
receive a first set of votes from each of the first set of wearable display devices, wherein each of the first set of votes is indicative of a first requested quality level of the first frame, wherein to render the first frame, the processor is configured to render the first frame based on the first set of votes; and
receive a second set of votes from each of the second set of wearable display devices, wherein each of the second set of votes is indicative of a second requested quality level of the second frame, wherein to render the second frame, the processor is configured to render the second frame based on the second set of votes.

11. The apparatus of claim 10, wherein each of the first set of votes is based on a first battery level of each of the first set of wearable display devices, wherein each of the second set of votes is based on a second battery level of each of the second set of wearable display devices.

12. The apparatus of claim 10, wherein the first set of votes is indicative of a first minimum quality level of the first frame, and wherein the second set of votes is indicative of a second minimum quality level of the second frame.

13. The apparatus of claim 10, wherein to render the first frame, the processor is configured to render the first frame at a first quality level, wherein the processor is further configured to:
assign, based on the rendering of the first frame, a third wearable display device to the first capability region based on third capability information of the third wearable display device;
receive a third set of votes from each wearable display device in the first capability region, wherein each of the third set of votes is indicative of a third requested quality level; and
render a third frame at a second quality level based on the third set of votes.

14. The apparatus of claim 1, wherein to render the first frame, the processor is configured to render the first frame based on a battery level of a companion device, and wherein to render the second frame, the processor is configured to render the second frame based on the battery level of the companion device.

15. The apparatus of claim 1, wherein the processor is further configured to:
obtain first pose information of the first wearable display device and second pose information of the second wearable display device, wherein to render the first frame, the processor is configured to render the first frame based on the first pose information, and wherein to render the second frame, the processor is configured to render the second frame based on the second pose information.

16. The apparatus of claim 1, wherein the processor is further configured to:
render a base frame, wherein to render the first frame, the processor is configured to render the first frame based on the base frame and the first capability information, and wherein to render the second frame, the processor is configured to render the second frame based on the base frame and the second capability information.

17. The apparatus of claim 16, wherein to render the first frame based on the base frame and the first capability information, the processor is configured to scale the first frame according to a first scaling, and wherein to render the second frame based on the base frame and the second capability information, the processor is configured to scale the second frame according to a second scaling that is different from the first scaling.

18. The apparatus of claim 1, wherein the first frame is associated with a first reprojection for the first wearable display device, wherein the second frame is associated with a second reprojection for the second wearable display device, and wherein the second reprojection is different from the first reprojection;
wherein the apparatus is a wireless communication device comprising at least one of a transceiver or an antenna coupled to the processor, wherein to transmit the rendered first frame and the rendered second frame, the processor is configured to transmit the rendered first frame and the rendered second frame via at least one of the transceiver or the antenna.

19. A method of graphics processing, comprising:
obtaining first capability information for a first wearable display device and second capability information for a second wearable display device;
rendering, based on the first capability information, a first frame for the first wearable display device;
rendering, based on the second capability information, a second frame for the second wearable display device; and
transmitting the rendered first frame for the first wearable display device and the rendered second frame for the second wearable display device.

20. A computer-readable medium storing computer executable code, the computer executable code, when executed by a processor, causes the processor to:
obtain first capability information for a first wearable display device and second capability information for a second wearable display device;
render, based on the first capability information, a first frame for the first wearable display device;
render, based on the second capability information, a second frame for the second wearable display device; and
transmit the rendered first frame for the first wearable display device and the rendered second frame for the second wearable display device.
